(19) United States
(12) Patent Application Publication
(10) Pub. No.: US 2011/0306257 A1
(43) Pub. Date: Dec. 15, 2011

(54) LONG-TERM OUTDOOR EXPOSURE RESISTANT POLYESTER COMPOSITE STRUCTURES AND PROCESSES FOR THEIR PREPARATION

(75) Inventor: THIERRY ARPIN, AMBILLY (FR)

(73) Assignee: E. I. DU PONT DE NEMOURS AND COMPANY, Wilmington, DE (US)

(21) Appl. No.: 13/051,263

(22) Filed: Mar. 18, 2011

Related U.S. Application Data
(60) Provisional application No. 61/354,362, filed on Jun. 14, 2010.

(51) Int. Cl. B32B 27/06; B32B 27/36

(52) U.S. Cl. 442/131

(57) ABSTRACT

Disclosed herein are ultraviolet light stabilized thermoplastic polyester composite structures wherein the surface has at least a portion made of a surface resin composition, and comprise a fibrous material impregnated with a matrix resin composition, wherein the surface resin composition is selected from polyester compositions comprising a) one or more polyester resins, and b) at least three UV stabilizers.

### CROSS REFERENCE TO RELATED APPLICATIONS

This application claims the benefit of U.S. Provisional Application No. 61/354,362 filed Jun. 14, 2010, now pending, the entire disclosure of which is incorporated herein by reference.

### FIELD OF THE INVENTION

The present invention relates to the field of ultraviolet light stabilized thermoplastic polyester composite structures, and processes for their preparation.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the combination of the fibrous material and the polymer matrix and are used in various end-use applications. Manufacturing techniques have been developed for improving the impregnation of the fibrous material with a polymer matrix to optimize the properties of the composite structure.

In highly demanding applications, such as for example structural parts in automotive and aerospace applications, composite materials are desired due to a unique combination of light weight, high strength and temperature resistance.

High performance composite structures can be obtained using thermosetting resins or thermoplastic resins as the polymer matrix. Thermoplastic-based composite structures present several advantages over thermoset-based composite structures such as, for example, the fact that they can be post-formed or reprocessed by the application of heat and pressure; a reduced time is needed to make the composite structures because no curing step is required; and they have increased potential for recycling. Indeed, the time consuming chemical reaction of cross-linking for thermosetting resins (curing) is not required during the processing of thermoplastics.

As a result of their good heat resistance, mechanical strength, electrical properties, good processability and other properties, thermoplastic polyesters are used in a broad range of applications including motorized vehicles applications; recreation and sport parts; household appliances, electrical/electronic parts; power equipment; and buildings or mechanical devices.

Examples of composite structures based on thermoplastic polyesters are disclosed in U.S. Pat. No. 4,549,920 and U.S. Pat. No. 6,369,157.

U.S. Pat. No. 4,549,920 discloses a fiber-reinforced composite structure made of a thermoplastic polyester, e.g. a polyethylene terephthalate (PET) resin, and reinforcing filaments encased within said resin.

U.S. Pat. No. 6,369,157 discloses a thermoplastic polyester composite structure. The disclosed composite structure is made by impregnating a fibrous material with oligomers of polyesters that rapidly polymerize in situ to form said composite structure.

U.S. Pat. App. Pub. No. 2007/0182047 discloses a method for producing a thermoplastic polyester composite structure. The disclosed method comprises the steps of impregnating a fibrous material with oligomers of polyester, particularly cyclic oligomers of PBT, and coating on one or both sides with an outer layer container a polymerized polyester. The oligomers of polyester rapidly polymerize during the manufacture of the composite structure.

U.S. Pat. No. 5,011,523 discloses a thermoplastic composite made of a commingled fibrous material that is formed from commingled thermoplastic polyester fibers and glass fibers. The fibrous material, i.e. the glass fibers, is impregnated by heat and pressure with the thermoplastic polyester present in the commingled fibrous material.

Many of applications using polyesters are used outdoors and require that composites made from polyesters be exposed to weathering conditions during normal use. If used in outdoor applications, composites structures comprising a polyester resin composition can be subject to rapid and severe degradation/deterioration because of weathering conditions such as for example high temperature, humidity, exposure to ultraviolet (UV) and other kind of radiations. Such kind of exposures to ultraviolet radiation and high temperature sources impair the properties of the article during normal use. Upon prolonged weathering conditions, composite structures comprising a polyester resin composition can degrade, thus leading to a loss of physical/mechanical properties and a diminished aesthetic appearance, for example discoloration and/or surface cracking.

Unfortunately, conventional polyester composite structures may suffer from an unacceptable deterioration of their mechanical properties and aesthetic appearance upon a long-term weathering exposure and upon a long-term high temperature exposure. For this reason, the existing technologies may be insufficient for highly demanding applications.

Consequently, there is a need for an efficient protection of polyester composite structures against deterioration due to a weathering exposure, in particular light-induced degradation, and heat-induced thermo-oxidation.

### SUMMARY OF THE INVENTION

Described herein is a composite structure having a surface, which surface has at least a portion made of a surface resin composition, and comprising a fibrous material selected from non-woven structures, textiles, fibrous battings and combinations thereof, said fibrous material being impregnated with a matrix resin composition, and wherein the surface resin composition is chosen from polyester compositions comprising a) one or more polyester resins, and b) from at or about 0.3 to at or about 3 wt-% of at least three UV stabilizers; wherein one of the at least three UV stabilizers is b1), another one is b2), and another one is b3), the weight percentages being based on the total weight of the polyester composition.

Further described herein are processes for making the composite structure described above. The process for making the composite structure described above comprises a step of i) impregnating with the matrix resin composition the fibrous material, wherein at least a portion of the surface of the composite structure is made of the surface resin composition.

### DETAILED DESCRIPTION

Several patents and publications are cited in this description. The entire disclosure of each of these patents and publications is incorporated herein by reference.

As used herein, the term “a” refers to one as well as to at least one and is not an article that necessarily limits its referent noun to the singular.

As used herein, the terms “about” and “at or about” are intended to mean that the amount or value in question may be the value designated or some other value about the same. The phrase is intended to convey that similar values promote equivalent results or effects according to the invention.

The present invention relates to composite structures and processes to make them. The composite structure according to the present invention comprises a fibrous material that is impregnated with a matrix resin composition. At least a portion of the surface of the composite structure is made of a surface resin composition. The matrix resin composition and the surface resin composition may be identical or may be different.

As used herein, the term “a fibrous material being impregnated with a matrix resin composition” means that the matrix resin composition encapsulates and embeds the fibrous material so as to form an interpenetrating network of fibrous material substantially surrounded by the matrix resin composition. For purposes herein, the term “fiber” refers to a macroscopically homogeneous body having a high ratio of length to width across its cross-sectional area perpendicular to its length. The fiber cross section can be any shape, but is typically round. The fibrous material may be in any suitable form known to those skilled in the art and is preferably selected from non-woven structures, textiles, fibrous battings and combinations thereof. Non-woven structures can be selected from random fiber orientation or aligned fibrous structures. Examples of random fiber orientation include without limitation chopped and continuous material which can be in the form of a mat, a needled mat or a felt. Examples of aligned fibrous structures include without limitation unidirectional fiber strands, bidirectional strands, multidirectional strands, multi-axial textiles. Textiles can be selected from woven forms, knits, braids and combinations thereof. The fibrous material can be continuous or discontinuous in form. Depending on the end-use application of the composite structure and the required mechanical properties, more than one fibrous materials can be used, either by using several same fibrous materials or a combination of different fibrous materials, i.e. the composite structure according to the present invention may comprise one or more fibrous materials. An example of a combination of different fibrous materials is a combination comprising a non-woven structure such as for example a planar random mat which is placed as a central layer and one or more woven continuous fibrous materials that are placed as outside layers. Such a combination allows an improvement of the processing and thereof of the homogeneity of the composite structure thus leading to improved mechanical properties. The fibrous material may be made of any suitable material or a mixture of materials provided that the material or the mixture of materials withstand the processing conditions used during impregnation by the matrix resin composition and the surface resin composition.

Preferably, the fibrous material comprises glass fibers, carbon fibers, aramid fibers, graphite fibers, metal fibers, ceramic fibers, natural fibers or mixtures thereof; more preferably, the fibrous material comprises glass fibers, carbon fibers, aramid fibers, natural fibers or mixtures thereof; and still more preferably, the fibrous material comprises glass fibers, carbon fibers and aramid fibers or mixture mixtures thereof. By natural fiber, it is meant any of material of plant origin or of animal origin. When used, the natural fibers are preferably derived from vegetable sources such as for example from seed hair (e.g. cotton), stem plants (e.g. hemp, flax, bamboo; both bast and core fibers), leaf plants (e.g. sisal and abaca), agricultural fibers (e.g., cereal straw, corn cobs, rice hulls and coconut hair) or lignocellulosic fiber (e.g. wood, wood fibers, wood flour, paper and wood-related materials). As mentioned above, more than one fibrous materials can be used. A combination of fibrous materials made of different fibers can be used such as for example a composite structure comprising one or more central layers made of glass fibers or natural fibers and one or more surface layers made of carbon fibers or glass fibers. Preferably, the fibrous material is selected from woven structures, non-woven structures or combinations thereof, wherein said structures are made of glass fibers and wherein the glass fibers are E-glass filaments with a diameter between 6 and 30 microns and preferably with a diameter between 10 to 24 microns.

The fibrous material may further contain a thermoplastic material and the materials described above, for example the fibrous material may be in the form of commingled or co-woven yarns or a fibrous material impregnated with a powder made of a thermoplastic material that is suited to subsequent processing into woven or non-woven forms, or a mixture for use as a uni-directional material or a fibrous material impregnated with oligomers that will polymerize in situ during impregnation.

Preferably, the ratio between the fibrous material and the polymer materials in the composite structure, i.e. the fibrous material in combination with the matrix resin composition and the surface resin composition, is at least 30% fibrous material and more preferably between 40 and 60% fibrous material, the percentage being a volume-percentage based on the total volume of the composite structure.

The matrix resin composition is made of a composition comprising a thermoplastic resin that is compatible with the surface resin composition; preferably, the matrix resin composition is made of a composition comprising one or more polyester resins or is chosen from polyester compositions comprising a) one or more polyester resins, and b) at least three UV stabilizers, as described for the surface resin composition. This means that the matrix resin composition and the surface resin composition may be identical or different. When the matrix resin composition is chosen from the polyester compositions comprising a) one or more polyester resins and b) at least three UV stabilizers, it may be identical or different from the surface resin composition. When the surface resin composition and the matrix resin composition are different, it means that the component a), i.e. the one or more polyester resins, and/or the component b), i.e. the at least three UV stabilizers, are not the same and/or that the amounts of component a) and b) are different in the surface resin composition and the matrix resin composition.

The one or more polyester resins are selected from thermoplastic polyesters derived from one or more dicarboxylic acids and one or more diols. Thermoplastic polyesters are typically derived from one or more dicarboxylic acids (where herein the term “dicarboxylic acid” also refers to dicarboxylic acid derivatives such as esters) and one or more diols. In preferred thermoplastic polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other dicarboxylic acids that may be used to form the thermoplastic polyester include sebacic and adipic acids. Hydroxycarboxylic acids such as hydroxybenzoic acid may be used as comonomers. Preferably, the one or more polyester resins comprised in the polyester composition described herein are independently selected from poly(ethylene terephthalate) (PET), poly(trimethylene terephthalate) (PTT), poly(1,4-butylene terephthalate) (PBT), poly(ethylene 2,6-naphthoate) (PEN), and poly(1,4-cyclohexyldimethylene terephthalate) (PCT) and copolymers and blends thereof. More preferably, the one or more thermoplastic polyesters comprised in the polyester composition described herein are independently selected from poly(ethylene terephthalate) (PET), poly(1,4-butylene terephthalate) (PBT), poly(1,4-cyclohexyldimethylene terephthalate) (PCT) and copolymers and blends thereof.

The polyester compositions described herein preferably comprise from at or about 0.3 to at or about 3 wt-% of at least three UV stabilizers, wherein one of the at least three UV stabilizers is b1), another one is b2) and another one is b3), the weight percentage being based on the total weight of the polyester composition.

Preferably, the at least three UV stabilizers are selected from the group consisting of b1) one or more benzotriazole derivatives, b2) one or more triazine derivatives and/or pyrimidine derivatives; and b3) one or more hindered amine derivatives (also known as hindered amine type light stabilizers (HALS)).

Preferably, the one or more benzotriazole derivatives b1) are present in an amount from at or about 0.01 to at or about 2.98 wt-%, the one or more triazine derivatives and/or pyrimidine derivatives b2) are present in an amount from at or about 0.01 to at or about 2.98 wt-%, and the one or more hindered amine derivatives b3) are present in an amount from 0.01 to at or about 2.98 wt-%, provided that the sum of b1)+b2)+b3) is between at or about 0.3 and at or about 3 wt-%, the weight percentage being based on the total weight of the polyester composition.

Preferably, one of the three UV stabilizers is one or more benzotriazole derivatives b1) having the following general formula (A) and combinations thereof:

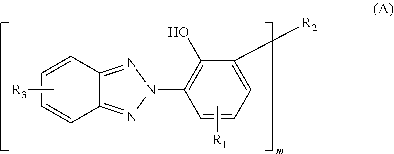

wherein R₁ is C₁-C₁₂ alkyl; C₁-C₅ alkoxy; C₁-C₅ alkoxycarbonyl; C₅-C₇ cycloalkyl; C₆-C₁₀ aryl; or aralkyl;
R₃ is hydrogen; C₁-C₅ alkyl; C₁-C₅ alkoxy; halogen, preferably chlorine; or hydroxy;
m is 1 or 2;
when m=1, R₂ is hydrogen; unsubstituted or phenyl-substituted C₁-C₁₂ alkyl; or C₆-C₁₀ aryl;
when m=2, R₂ is a direct bond between the phenyl groups; or —(CH₂)ₚ—; and p is from 1 to 3.

By “combination thereof”, it is generally understood that when more than one stabilizers of the one or more benzotriazole derivatives b1), for example, are present in the polyester composition, the different stabilizers b1) can have different structures and can be independently selected from the general formula (A), all of these stabilizers having the general formula (A).

More preferably, the one or more benzotriazole derivatives b1) have the following general formula (B) and combinations thereof:

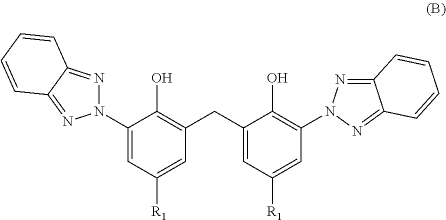

wherein R₁ is an C₁-C₁₂ alkyl.

Still more preferably, the one or more benzotriazole derivatives b1) have the following general formula (C):

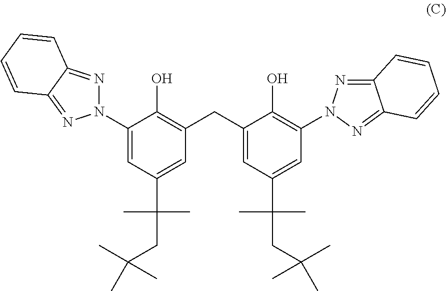

which benzotriazole derivative is 2,2′-methylenebis(6-(2H-benzotriazol-2-yl)-4-1,1,3,3-tetramethylbutyl)-phenol ((CAS number: 103597-45-1; also referred to 2,2′-methylenebis(6-(benzotriazol-2-yl)-4-tert-octylphenol)).

Preferably, the one or more benzotriazole derivatives b1) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1)+b2)+b3) is between 0.3 and 3 wt-%, the weight percentage being based on the total weight of the polyester composition.

Preferably, one of the three UV stabilizers is one or more triazine derivatives and/or pyrimidine derivatives b2) having the following general formula (D) and combinations thereof:

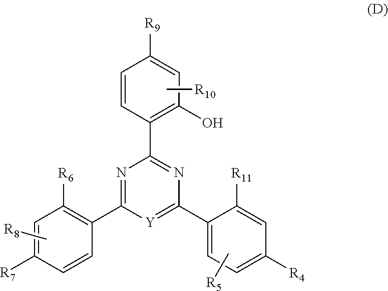

wherein Y is N (triazine derivative) or CH (pyrimidine derivative); and wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, or a combination thereof.

More preferably, the one or more triazine derivatives and/or pyrimidine derivatives b2) are triazine derivatives, i.e. Y is N (nitrogen), of the following formula (E) and combinations thereof:

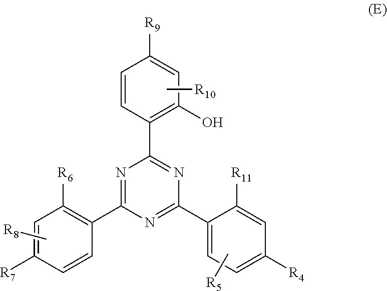

wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, or a combination thereof.

Still more preferably, the one or more triazine derivatives and/or pyrimidine derivatives b2) are compounds of the following general formula (F):

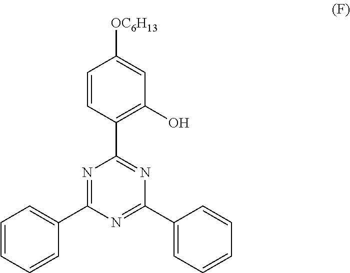

which triazine derivatives and/or pyrimidine derivatives is 2-(4,6-diphenyl-1,3,5-triazin-2-yl)-5-hexyloxy-phenol (CAS Nb 147315-50-2).

Preferably, the one or more triazine derivatives and/or pyrimidine derivatives b2) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1)+b2)+b3) is between 0.3 and 3 wt-%, the weight percentage being based on the total weight of the polyester composition.

Preferably, one of the three UV stabilizers is one or more hindered amine derivatives b3) having the following formulas (G) and combinations thereof:

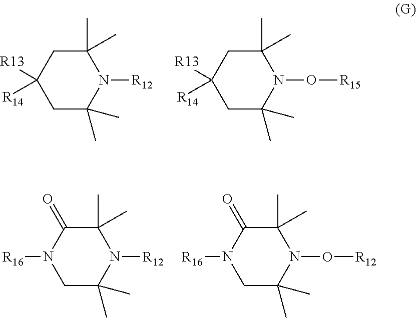

wherein R₁₂, R₁₃, R₁₄, R₁₅ and R₁₆ are each independently selected from the group consisting of hydrogen, ether groups, ester groups, amine groups, amide groups, alkyl groups, alkenyl groups, alkynyl groups, aralkyl groups, cycloalkyl groups, aryl groups or a combination thereof; in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. The one or more hindered amine derivatives may also form part of a polymer or oligomer.

More preferably, the one or more hindered amine derivatives b3) are compounds derived from a substituted piperidine compound, in particular any compound derived from an alkyl-substituted piperidyl, piperidinyl or piperazinone compound, and substituted alkoxypiperidinyl compounds. Still more preferably, the one or more hindered amine derivatives b3) are an oligomer of N-(2-hydroxyethyl)-2,2,6,6-tetramethyl-4-piperidinol and succinic acid, which oligomer has a molecular weight Mₙ of 3100-4000. (CAS number: 65447-77-0).

Preferably, the one or more hindered amine derivatives b3) are present in an amount from at or about 0.01 to at or about 2.98 wt-%, more preferably from at or about 0.05 to at or about 2 wt-% and still more preferably from at or about 0.1 to at or about 1 wt-%, provided that the sum of b1)+b2)+b3) is between 0.3 and 3 wt-%, the weight percentage being based on the total weight of the polyester composition.

According to a preferred embodiment, the at least three UV stabilizers are:

b1) having the general formula (A) described above,
b2) having the general formula (D) described above, and
b3) having the general formula (G) described above.

According to a a more preferred embodiment, the at least three UV stabilizers are:
b1) being 2,2′-methylenebis(6-(2H-benzotriazol-2-yl)-4-1,1,3,3-tetramethylbutyl)-phenol,
b2) being 2-(4,6-diphenyl-1,3,5-triazin-2-yl)-5-hexyloxy-phenol, and
b3) being an oligomer of N-(2-hydroxyethyl)-2,2,6,6-tetramethyl-4-piperidinol and succinic acid.

The surface resin composition described herein and/or the matrix resin composition may further comprise one or more tougheners, one or more heat stabilizers, one or more reinforcing agents, one or more flame retardant agents or mixtures thereof.

The surface resin composition and/or the matrix resin composition may further comprise one or more tougheners. The toughener will typically be an elastomer having a relatively low melting point, generally lower than 200° C., preferably lower than 150° C. and that is a functionalized polymer so as to react with the carboxyl and/or hydroxyl groups of the one or more polyesters (and optionally other polymers present). By “functionalized polymer”, it is meant that the polymer, which can be a homopolymer, a copolymer or a terpolymer, is grafted and/or copolymerized with organic functionalities. Suitable organic functionalities are epoxy, carboxylic anhydride, hydroxyl (alcohol), carboxyl and isocyanate functionalities. As an example of grafting, maleic anhydride may be grafted onto a hydrocarbon rubber using free radical grafting techniques. An example of a toughener wherein the organic functionalities are copolymerized into the polymer is a copolymer of ethylene and a (meth)acrylate monomer containing the appropriate functional group such as for example (meth)acrylic acid, 2-hydroxyethyl (meth)acrylate, glycidyl (meth)acrylate (GMA), and 2-isocyanatoethyl (meth)acrylate with optionally other monomers that may be copolymerized into such a polymer, such as vinyl acetate, unfunctionalized (meth)acrylate esters such as ethyl (meth)acrylate, n-butyl (meth)acrylate, and cyclohexyl (meth)acrylate. Especially preferred tougheners are copolymers of ethylene, alkyl acrylate and glycidyl methacrylate, such as EBAGMA, and ethylene/methyl acrylate copolymers. The one or more tougheners may also be ionomers. Ionomers are thermoplastic resins that contain metal ions in addition to the organic backbone of the polymer. Ionomers are ionic copolymers formed from an olefin such as ethylene and alpha,beta-unsaturated C₃-C₈ carboxylic acid, such as for example acrylic acid (AA), methacrylic acid (MAA) or maleic acid monoethylester (MAME), wherein at least some of the carboxylic acid moieties, preferably form 10 to 99.9%, in the copolymer are neutralized with a neutralizing (e.g. alkali metals like lithium, sodium or potassium or transition metals like manganese or zinc) to form the corresponding carboxylate salts. The polymeric toughener may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like. Copolymers derived from two or more of the forgoing types of monomers may also be used, as well as copolymers made by polymerizing one or more of the forgoing types of monomers with styrene, acrylonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate. It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition. When present, the one or more tougheners preferably comprise from at or about 0.5 to at or about 30 wt-%, or more preferably from at or about 1 to at or about 20 wt-%, the weight percentages being based on the total weight of the surface resin composition or the matrix resin composition, as the case may be.

The surface resin composition and/or the matrix resin composition may further comprise one or more heat stabilizers (also referred as antioxidants or oxidative stabilizers) that hinder thermally induced oxidation of polymers where high temperature applications are used. Preferably, the one or more oxidative stabilizers are selected from phenolic-based stabilizers, phosphorus-based stabilizers, hindered amine stabilizers, aromatic amine stabilizers, thioesters and mixtures thereof so as to hinder thermally induced oxidation of polyesters where high temperature applications are used. More preferably, the one or more oxidative stabilizers are selected from phenolic-based stabilizers, phosphorus-based stabilizers and mixtures thereof. Preferred examples of phenolic-based antioxidants are sterically hindered phenols. Preferred examples of phosphorus-based antioxidants are phosphite stabilizers, hypophosphite stabilizers and phosphonite stabilizers and more preferably diphosphite stabilizers. When present, the one or more oxidative stabilizers comprise from at or about 0.1 to at or about 3 wt-%, or preferably from at or about 0.1 to at or about 1 wt-%, or more preferably from at or about 0.1 to at or about 0.8 wt-%, the weight percentages being based on of the total weight of the surface resin composition or the matrix resin composition, as the case may be. The addition of the one or more heat stabilizers improves the thermal stability of the composite structure during its manufacture (i.e. a decreased molecular weight reduction) as well as its thermal stability upon use and time. In addition to the improved heat stability, the presence of the one or more heat stabilizers may allow an increase of the temperature that is used during the impregnation of the composite structure thus reducing the melt viscosity of the matrix resin and/or the surface resin composition described herein. As a consequence of a reduced melt viscosity of the matrix resin and/or the surface resin composition, impregnation rate may be increased.

The surface resin composition described herein and/or the matrix resin composition may further comprise one or more reinforcing agents such as non-circular cross-sectional fibrous glass fillers; glass fibers having a circular cross section, glass flakes, carbon fibers, carbon nanotubes, mica, wollastonite, calcium carbonate, talc, calcinated clay, kaolin, magnesium sulfate, magnesium silicate, boron nitride, barium sulfate, titanium dioxide, sodium aluminum carbonate, barium ferrite, and potassium titanate. When present, the one or more reinforcing agents are present in an amount from at or about 1 to at or about 60 wt-%, preferably from at or about 1 to at or about 40 wt-%, or more preferably from at or about 1 to at or about 35 wt-%, the weight percentages being based on the total weight of the surface resin composition or the matrix resin composition, as the case may be.

The surface resin composition described herein and/or the matrix resin composition may further comprise additional ultraviolet light stabilizers. Preferably, the additional ultraviolet light stabilizers are selected from hindered amine light stabilizers (HALS), carbon black, substituted resorcinols, salicylates, benzotriazoles, triazines, benzophenones and mixtures thereof. When present, additional ultraviolet light stabilizers are present in an amount from at or about 0.1 to at or about 5 wt-%, preferably from at or about 0.2 to at or about 3 wt-%, the weight percentages being based on the total weight of the surface resin composition or the matrix resin composition, as the case may be.

The surface resin composition described herein and/or the matrix resin composition may further comprise one or more flame retardants (also referred to in the art as flameproofing agents). Flame retardants are used in thermoplastic compositions to suppress, reduce, delay or modify the propagation of a flame through the composition or an article based on the composition. The one or more flame retardants may be halogenated flame retardants, inorganic flame retardants, phosphorous containing compounds, nitrogen containing compounds or a combination thereof.

Halogenated organic flame retardants include without limitation chlorine- and bromine-containing compounds. Examples of suitable chlorine-containing compounds include without limitation chlorinated hydrocarbons, chlorinated cycloaliphatic compounds, chlorinated alkyl phosphates, chlorinated phosphate esters, chlorinated polyphosphates, chlorinated organic phosphonates, chloroalkyl phosphates, polychlorinated biphenyls and chlorinated paraffins. Examples of suitable bromine-containing compounds include without limitation tetrabromobisphenol A, bis(tribromophenoxy) alkanes, polybromodiphenyl ethers, brominated phosphate esters tribromophenol, tetrabromodiphenyl sulfides, polypentabromo benzyl acrylate, brominated phenoxy resins, brominated polycarbonate polymeric additives based on tetrabromobisphenol A, brominated epoxy polymeric additives based on tetrabromobisphenol A and brominated polystyrenes.

Inorganic flame retardants include without limitation metal hydroxides, metal oxides, antimony compounds, molybdenum compounds and boron compounds. Examples of suitable metal hydroxides include without limitation magnesium hydroxide, aluminum hydroxide, aluminum trihydroxide and other metal hydroxides. Examples of suitable metal oxides include without limitation zinc and magnesium oxides. Examples of suitable antimony compounds include without limitation antimony trioxide, sodium antimonite and antimony pentoxide. Examples of suitable molybdenum compounds include without limitation molybdenum trioxide and ammonium octamolybdate (AOM). Examples of suitable boron compounds include without limitation include zinc borate, borax (sodium borate), ammonium borate and calcium borate.

Examples of suitable phosphorous containing compounds include without limitation red phosphorus; halogenated phosphates; triphenyl phosphates; oligomeric and polymeric phosphates; phosphonates phosphinates, disphosphinate and/or polymers thereof.

Examples of suitable nitrogen containing compounds include without limitation triazines or derivatives thereof, guanidines or derivatives thereof, cyanurates or derivatives thereof and isocyanurates or derivatives thereof.

When present, the one or more flame retardants comprise from at or about 5 to at or about 30 wt-%, or preferably from at or about 10 to at or about 25 wt-%, the weight percentages being based on of the total weight of the surface resin composition or the matrix resin composition, as the case may be.

As mentioned above, the matrix resin composition and the surface resin composition may be identical or different. With the aim of increasing the impregnation rate of the fibrous material, the melt viscosity of the compositions may be reduced and especially the melt viscosity of the matrix resin composition. With the aim of improving the manufacture of composite structures and allowing an easier, shorter and uniform impregnation of the fibrous material, several ways have been developed to decrease the melt viscosity of the polymer matrix. By having a melt viscosity as low as possible, polymer compositions flow faster and the impregnation of the fibrous material is faster and better. By reducing the melt viscosity of the polymer matrix, the limiting impregnation time needed to reach the degree of impregnation may be shortened, thereby increasing the overall manufacturing speed and thus leading to an increased productivity of the manufacture of the structures and to a decrease of energy consumption associated with a shorter cycle time which is beneficial also for environmental concerns. In addition to the improved throughput, an increased impregnation rate also minimizes the thermal degradation of the matrix composition. With the aim of reducing the melt viscosity of the matrix resin composition, the matrix resin composition described herein may further comprise one or more rheology modifiers selected from hyperbranched polymers (also known as hyperbranched polymers, dendritic or highly branched polymers, dendritic macromolecules or arborescent polymers), polyhydric alcohols, polyphenols and LCP block copolymers. Hyperbranched polymers are three dimensional highly branched molecules having a treelike structure. Hyperbranched polymers are macromolecules that comprise one or more branching comonomer units. The branching units comprise branching layers and optionally a nucleus (also known as core), one or more spacing layers and/or a layer of chain terminating molecules. Continued replication of the branching layers yields increased branch multiplicity, branch density, and an increased number of terminal functional groups compared to other molecules. Preferred hyperbranched polymers include hyperbranched polyesters. Preferred examples of hyperbranched polymers are those described in U.S. Pat. No. 5,418,301 U.S. Pat. App. Pub. No. 2007/0173617. The use of such hyperbranched polymers in thermoplastic resins is disclosed in U.S. Pat. No. 6,225,404, U.S. Pat. No. 6,497,959, U.S. Pat. No. 6,663,966, Int'l Pat. App. Pub. No. WO 2003/004546, European Pat. App. No. 1424360 and Int'l Pat. App. Pub. No. WO 2004/111126. When present, the one or more hyperbranched polymers comprise from at or about 0.05 to at or about 10 wt-%, or more preferably from at or about 0.1 to at or about 5 wt-%, the weight percentage being based on the total weight of the matrix resin composition.

Depending on the end-use application of composite structure according to the present and the hydrolysis resistance requirement for such applications, the surface resin composition described herein and/or the matrix resin composition may further comprise one or more epoxy-containing compounds. Examples of suitable epoxy-containing compounds include without limitation an epoxy containing polyolefin, a glycidyl ether of polyphenols, a bisphenol epoxy resin and an epoxy novolac resin. Epoxy containing polyolefins are polyolefins, preferably polyethylene, that are functionalized with epoxy groups; by “functionalized”, it is meant that the groups are grafted and/or copolymerized with organic functionalities. Examples of epoxides used to functionalize polyolefins are unsaturated epoxides comprising from four to eleven carbon atoms, such as glycidyl (meth)acrylate, allyl glycidyl ether, vinyl glycidyl ether and glycidyl itaconate, glycidyl (meth)acrylates (GMA) being particularly preferred. Ethylene/glycidyl (meth)acrylate copolymers may further contain copolymerized units of an alkyl (meth)acrylate having from one to six carbon atoms and an α-olefin having 1-8 carbon atoms. Representative alkyl (meth)acrylates include methyl (meth)acrylate, ethyl (meth)acrylate, propyl (meth)acrylate, butyl (meth)acrylate, isobutyl (meth)acrylate, hexyl (meth)acrylate, or combinations of two or more thereof. Of note are ethyl acrylate and butyl acrylate. Bisphenol epoxy resins are condensation products having epoxy functional groups and a bisphenol moiety. Examples include without limitation products obtained from the condensation of bisphenol A and epichlorohydrin and products obtained from the condensation of bisphenol F and epichlorohydrin. Epoxy novolac resins are condensation products of an aldehyde such as for example formaldehyde and an aromatic hydroxyl-containing compound such as for example phenol or cresol. When present, the one or more epoxy-containing compounds are present in an amount sufficient to provide from at or about 3 to at or about 300 milliequivalents of total epoxy function per kilogram of the one or more thermoplastic polyesters comprised in the surface resin composition or per kilogram of the one or more thermoplastic polyesters comprised in the matrix resin composition, as the case may be; preferably from at or about 5 to at or about 300 milliequivalents of total epoxy function per kilogram of polyester.

The surface resin composition described herein and/or the matrix resin composition may further comprise modifiers and other ingredients, including, without limitation, lubricants, antistatic agents, coloring agents (including dyes, pigments, carbon black, and the like), nucleating agents, crystallization promoting agents and other processing aids known in the polymer compounding art.

Fillers, modifiers and other ingredients described above may be present in amounts and in forms well known in the art, including in the form of so-called nano-materials where at least one of the dimensions of the particles is in the range of 1 to 1000 nm.

Preferably, the surface resin compositions and the matrix resin compositions are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

Depending on the end-use application, the composite structure according to the present invention may have any shape. In a preferred embodiment, the composite structure according to the present invention is in the form of a sheet structure. The composite structure may be flexible, in which case it can be rolled.

In another aspect, the present invention relates to a process for making the composite structures described above and the composite structures obtained thereof. The process for making a composite structure having a surface comprises a step of i) impregnating the fibrous material with the matrix resin composition, wherein at least a portion of the surface of the composite structure is made of the surface resin composition. Also described herein are processes for making the composite structures described herein, wherein the processes comprise a step of applying a surface resin composition to at least a portion of the surface of the fibrous material which is impregnated with a matrix resin composition described herein. Preferably, the fibrous material is impregnated with the matrix resin by thermopressing. During thermopressing, the fibrous material, the matrix resin composition and the surface resin composition undergo heat and pressure in order to allow the resin compositions to melt and penetrate through the fibrous material and, therefore, to impregnate said fibrous material.

Typically, thermopressing is made at a pressure between 2 and 100 bars and more preferably between 10 and 40 bars and a temperature which is above the melting point of the matrix resin composition and the surface resin composition, preferably at least about 20° C. above the melting point to enable a proper impregnation. Heating may be done by a variety of means, including contact heating, radiant gas heating, infra red heating, convection or forced convection air heating, induction heating, microwave heating or combinations thereof.

The impregnation pressure can be applied by a static process or by a continuous process (also known as dynamic process), a continuous process being preferred for reasons of speed. Examples of impregnation processes include without limitation vacuum molding, in-mold coating, cross-die extrusion, pultrusion, wire coating type processes, lamination, stamping, diaphragm forming or press-molding, lamination being preferred. During lamination, heat and pressure are applied to the fibrous material, the matrix resin composition and the surface resin composition through opposing pressured rollers or belts in a heating zone, preferably followed by the continued application of pressure in a cooling zone to finalize consolidation and cool the impregnated fibrous material by pressurized means. Examples of lamination techniques include without limation calendering, flatbed lamination and double-belt press lamination. When lamination is used as the impregnating process, preferably a double-belt press is used for lamination.

The matrix resin composition and the surface resin composition are applied to the fibrous material by conventional means such as for example powder coating, film lamination, extrusion coating or a combination of two or more thereof, provided that the surface resin composition is applied on at least a portion of the surface of the composite structure, which surface is exposed to the environment of the composite structure.

During a powder coating process, a polymer powder which has been obtained by conventional grinding methods is applied to the fibrous material. The powder may be applied onto the fibrous material by scattering, sprinkling, spraying, thermal or flame spraying, or fluidized bed coating methods. Optionally, the powder coating process may further comprise a step which consists in a post sintering step of the powder on the fibrous material. The matrix resin composition and the surface resin composition are applied to the fibrous material such that at least a portion of the surface of the composite structure is made of the surface resin composition. Subsequently, thermopressing is performed on the powder coated fibrous material, with an optional preheating of the powder coated fibrous material outside of the pressurized zone.

During film lamination, one or more films made of the matrix resin composition and one or more films made of the surface resin composition which have been obtained by conventional extrusion methods known in the art such as for example blow film extrusion, cast film extrusion and cast sheet extrusion are applied to the fibrous material, e.g. by layering. Subsequently, thermopressing is performed on the assembly comprising the one or more films made of the matrix resin composition and the one or more films made of the surface resin composition and the one or more fibrous materials. In the resulting composite structure, the films melt and penetrate around the fibrous material as a polymer continuum surrounding the fibrous material.

During extrusion coating, pellets and/or granulates made of the matrix resin composition and pellets and/or granulates made of the surface resin composition are melted and extruded through one or more flat dies so as to form one or more melt curtains which are then applied onto the fibrous material by laying down the one or more melt curtains. Subsequently, thermopressing is performed on the assembly comprising the matrix resin composition, the surface resin composition and the one or more fibrous materials.

Depending on the end-use application, the composite structure obtained under step i) may be shaped into a desired geometry or configuration, or used in sheet form. The process for making a composite structure according to the present invention may further comprise a step ii) of shaping the composite structure, said step arising after the impregnating step i). The step of shaping the composite structure obtained under step i) may be done by compression molding, stamping or any technique using heat and/or pressure. Preferably, pressure is applied by using a hydraulic molding press. During compression molding or stamping, the composite structure is preheated to a temperature above the melt temperature of the surface resin composition and is transferred to a forming or shaping means such as a molding press containing a mold having a cavity of the shape of the final desired geometry whereby it is shaped into a desired configuration and is thereafter removed from the press or the mold after cooling to a temperature below the melt temperature of the surface resin composition and preferably below the melt temperature the matrix resin composition.

The composite structures according to the invention offer good stability against the deleterious effects of long-term weathering exposure and a good retention of mechanical properties upon high temperature exposure and therefore may be used in a wide variety of applications such as for example as components for automobiles, trucks, commercial airplanes, aerospace, rail, household appliances, computer hardware, hand held devices, recreation and sports, structural component for machines, structural components for buildings, structural components for photovoltaic equipments, structural components for wind energy (e.g. blades), or structural components for mechanical devices.

Examples of automotive applications include without limitation seating components and seating frames, engine cover brackets, engine cradles, suspension arms and cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning, heating and portable power generator housings. Examples of recreation and sports include without limitation inline-skate components, baseball bats, hockey sticks, ski and snowboard bindings, rucksack backs and frames, and bicycle frames. Examples of structural components for machines include electrical/electronic parts such as for example housings for hand held electronic devices, computers.

### EXAMPLES

The following materials were used for preparing the composites structures according to the present invention and comparative examples.

### Materials

The materials below make up the compositions used in the Examples and Comparative Examples.

Polyester 1: poly(ethylene terephthalate) supplied by Invista, Kans., USA under the trademark Polyclear® PET 1101.
Polyester 2: poly(1,4-butylene terephthalate) having a melt flow rate (MFR) from 42.5 to 53.6 g/10 min (measured according to ISO1133, 250° C., 2.16 kg). Such a product is commercially available from E.I. DuPont de Nemours and Company, Wilmington, Del., USA under the trademark Crastin®.
UV stabilizer b1: 2,2′-methylenebis(6-(2H-benzotriazol-2-yl)-4-1,1,3,3-tetramethylbutyl)-phenol (CAS Nb 103597-45-1) supplied by Ciba Specialty Chemicals, Tarrytown, N.Y., USA under the trademark Tinuvin® 360.
UV stabilizer b2: 2-(4,6-diphenyl-1,3,5-triazin-2-yl)-5-hexyloxy-phenol (CAS Nb 147315-50-2) supplied by Ciba Specialty Chemicals, Tarrytown, N.Y., USA under the trademark Tinuvin® 1577.
UV stabilizer b3: oligomer of N-(2-hydroxyethyl)-2,2,6,6-tetramethyl-4-piperidinol and succinic acid having a molecular weight Mₙ of 3100-4000 (CAS number: 65447-77-0), supplied by Ciba Specialty Chemicals, Tarrytown, N.Y., USA under the trademark Tinuvin® 622.

All the compositions 1-8 listed in Table 1 comprised other additives: 0.4 wt-% of a diphosphite based antioxidant, 0.4 wt-% of a phenolic based antioxidant, 0.8 wt-% of an epoxy resin and 0.4 wt-% of a phosphate salt, wherein the additives are:

Diphosphite based antioxidant: bis(2.4-di-tert-butylphenyl) pentaerythritol diphosphite supplied by G. E. Specialty Chemicals, Parkersburg, W. Va., USA under the trademark Ultranox® 626.
Phenolic based antioxidant: supplied by Ciba Specialty Chemicals, Tarrytown, N.Y., USA under the trademark Irganox® 1010.
Epoxy resin: epichlorohydrin/tetraphenylol ethane epoxy resin having an epoxy group content (ASTM D1652) of 4348-5128 mmol/kg, supplied by Hexion Speciality Chemicals, Columbus, Ohio, USA under the trademark Epon™ 1009.
Phosphate salt: sodium phosphate supplied by Budenheim, Germany under the name N 13-50.

Preparation of the compositions. The compositions listed in Table 1 were prepared by melt blending the ingredients shown in Table 1 in a 40 mm twin screw kneader operating at about 260° C. using a screw speed of about 300 rpm, a melt temperature displayed of about 267° C. and a melt temperature measured by hand of about 281° C. Upon exiting the extruder, the compositions were cooled and pelletized. The so-obtained pellets were ground by micronisation so as to form powder compositions which were sieved to particles having a D90 value less than 200 μm.

Preparation of the composite structures. The powder compositions listed in Table 1 were manually scattered onto 3 layers of woven continuous glass fiber sheets (E-glass fibers having a diameter of 17 microns, 0.4% of a silane-based sizing and a nominal roving tex of 1200 g/km that have been woven into a 2/2 twill (balance weave) with an areal weight of 600 g/m) so as to form assemblies comprising 6.4 g of powder composition/a glass fiber sheet having a size of 16 cm×16 cm/6.4 g of powder composition/a glass fiber sheet having a size of 16 cm×16 cm/6.4 g of powder composition/a glass fiber sheet having a size of 16 cm×16 cm/6.4 g of powder composition. The composite structures C1-C7 and E1 listed in Table 2 were prepared from the so-obtained assemblies by compression moulding (Dr. Collin press) according to the following conditions: 1) preheating the assemblies for 25 seconds at 315° C. and 110 bars, 2) maintaining these conditions for an additional time of 40 seconds, 3) cooling the assemblies for 60 seconds at 110 bars and 40° C. and 4) opening the press so as to recover the so-obtained composite structures. The composite structures listed in Table 2 had an overall thickness of about 1.5 mm.

TABLE 1

| | composition | | | | | | | |
|---|---|---|---|---|---|---|---|---|
| | 1 | composition 2 | composition 3 | composition 4 | composition 5 | composition 6 | composition 7 | composition 8 |
| Polyester 1 | 68.0 | 67.2 | 66.8 | 66.8 | 66.4 | 66.4 | 66.4 | 66.4 |
| Polyester 2 | 30.0 | 30.0 | 30.0 | 30.0 | 30.0 | 30.0 | 30.0 | 30.0 |
| UV stabiliser b1 | — | 0.4 | — | 0.4 | 0.8 | — | 0.8 | 0.4 |
| UV stabiliser b2 | — | — | 0.8 | 0.8 | — | 0.8 | 0.8 | 0.8 |
| UV stabiliser b3 | — | 0.4 | 0.4 | — | 0.8 | 0.8 | — | 0.4 |

TABLE 2

| | Composite | Composite | Composite | Composite | Composite | Composite | Composite | Composite |
|---|---|---|---|---|---|---|---|---|
| | structure C1 | structure C2 | structure C3 | structure C4 | structure C5 | structure C | structure C7 | structure E1 |
| Surface resin | Composition 1 | Composition 2 | Composition 3 | Composition 4 | Composition 5 | Composition 6 | Composition 7 | Composition 8 |
| composition | | | | | | | | |
| Matrix resin | Composition 1 | Composition 2 | Composition 3 | Composition 4 | Composition 5 | Composition 6 | Composition 7 | Composition 8 |
| composition | | | | | | | | |

What is claimed is:

1. A composite structure having a surface, which surface has at least a portion made of a surface resin composition, and comprising a fibrous material selected from non-woven structures, textiles, fibrous battings and combinations thereof, said fibrous material being impregnated with a matrix resin composition, wherein the surface resin composition is a polyester composition comprising:
a) one or more polyester resins, and
b) from about 0.3 to about 3 wt-% of at least three UV stabilizers; wherein one of the at least three UV stabilizers is b1), another one is b2), and another one is b3), the weight percentages being based on the total weight of the polyester composition.

2. The composite structure according to claim 1, wherein the matrix resin composition and the surface resin composition are identical or different and are independently chosen from polyester compositions comprising one or more polyester resins.

3. The composite structure according to claim 1, wherein the fibrous material is made of glass fibers, carbon fibers, aramid fibers, natural fibers or mixtures thereof.

4. The composite structure according to claim 1, wherein the one or more polyester resins are independently selected from the group consisting of poly(ethylene terephthalate) (PET), poly(trimethylene terephthalate) (PTT), poly(1,4-butylene terephthalate) (PBT), poly(ethylene 2,6-naphthoate) (PEN), and poly(1,4-cyclohexyldimethylene terephthalate) (PCT), copolymers thereof and blends thereof.

5. The composite structure according to claim 1, wherein the at least three UV stabilizers are selected from the group consisting of b1) one or more benzotriazole derivatives; b2) one or more triazine derivatives, pyrimidine derivatives, or both; and b3) one or more hindered amine derivatives.

6. The composite structure according to claim 5, wherein b1) is one or more benzotriazole derivatives being present in an amount from 5 about 0.01 to 5 about 2.98 wt-%, b2) is one or more triazine derivatives and/or pyrimidine derivatives being present in an amount from 5 about 0.01 to 5 about 2.98 wt-%, and b3) is one or more hindered amine derivatives being present in an amount from about 0.01 to about 2.98 wt-%,
provided the sum of b1)+b2)+b3) is between at or about 0.3 and at or about 3 wt-%,
the weight percentage being based on the total weight of the polyester composition.

7. The composite structure according to claim 5, wherein b1) is one or more benzotriazole derivatives having the following formula (A) and combinations thereof: 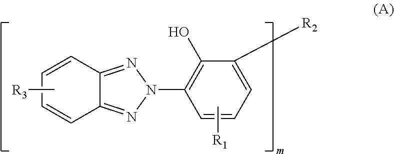
wherein R₁ is C₁-C₁₂ alkyl; C₁-C₅ alkoxy; C₁-C₅ alkoxycarbonyl; C₅-C₇ cycloalkyl; C₆-C₁₀ aryl; or aralkyl; R₃ is hydrogen; C₁-C₅ alkyl; or C₁-C₅ alkoxy; halogen; m is 1 or 2;
when m=1, R₂ is hydrogen; unsubstituted or phenyl-substituted C₁-C₁₂ alkyl; or C₆-C₁₀ aryl;
when m=2, R₂ is a direct bond between the phenyl groups; or —(CH₂)ₚ—; and p is from 1 to 3.

8. The composite structure according to claim 7, wherein b1) is 2,2′-methylenebis(6-(2H-benzotriazol-2-yl)-4-1,1,3,3-tetramethylbutyl)-phenol or has the following formula (C):

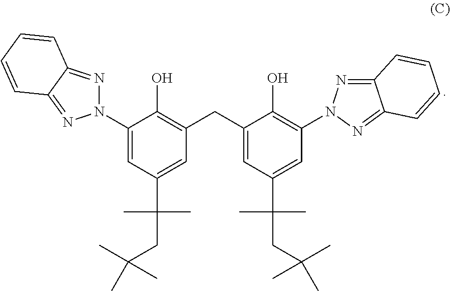

9. The composite structure according to claim 5, wherein b2) is one or more triazine derivatives and/or pyrimidine derivatives having the following formula (D) and combinations thereof: 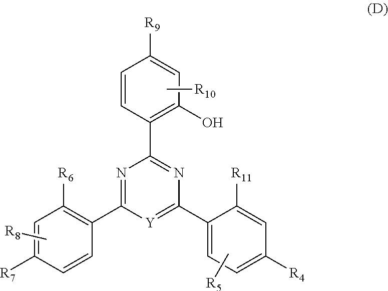
wherein Y is N (triazine derivative) or CH (pyrimidine derivative); and wherein R₄, R₅, R₆, R₇, R₈, R₉, R₁₀, and R₁₁ are each independently selected from the group consisting of hydrogen, alkyl, cycloalkyl, halogen, haloalkyl, alkoxy, alkylene, aryl, alkyl-aryl, and combinations thereof.

10. The composite structure according to claim 9, wherein b2) is 2-(4,6-diphenyl-1,3,5-triazin-2-yl)-5-hexyloxy-phenol or has the following formula (F):

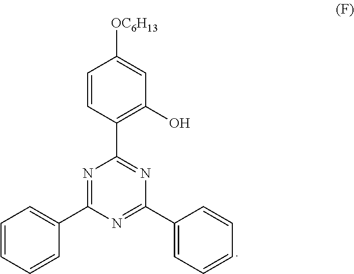

11. The composite structure according to claim 5, wherein b3) is one or more hindered amine derivatives having the following formulas (G) and combinations thereof: 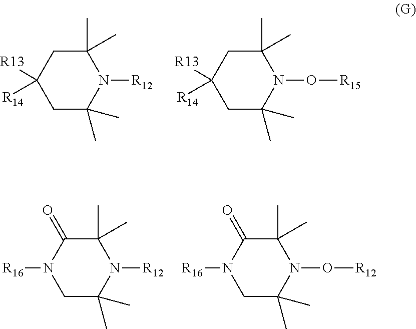
wherein R₁₂, R₁₃, R₁₄, R₁₅ and R₁₆ are each independently selected from the group consisting of hydrogen, ether groups, ester groups, amine groups, amide groups, alkyl groups, alkenyl groups, alkynyl groups, aralkyl groups, cycloalkyl groups, aryl groups and combinations thereof.

12. The composite structure according to claim 11, wherein b3) is an oligomer of N-(2-hydroxyethyl)-2,2,6,6-tetramethyl-4-piperidinol and succinic acid.

13. The composite structure according to claim 11, wherein:
b1) is 2,2′-methylenebis(6-(2H-benzotriazol-2-yl)-4-1,1,3,3-tetramethylbutyl)-phenol or has the following formula (C): 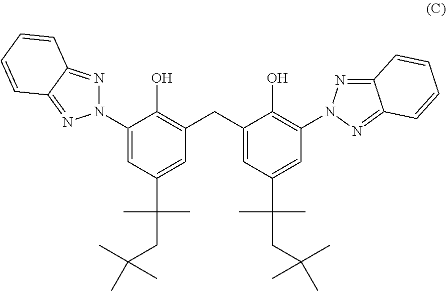
b2) is 2-(4,6-diphenyl-1,3,5-triazin-2-yl)-5-hexyloxy-phenol or has the following formula (F): 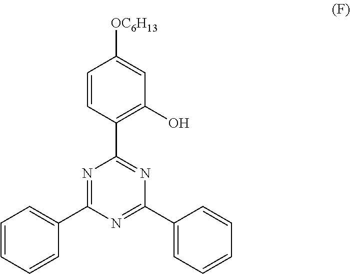
and b3) is an oligomer of N-(2-hydroxyethyl)-2,2,6,6-tetramethyl-4-piperidinol and succinic acid.

14. The composite structure according to claim 1 in the form of components for automobiles, trucks, commercial airplanes, aerospace, rail, household appliances, computer hardware, hand held devices, recreation and sports, structural component for machines, structural components for buildings, structural components for photovoltaic equipments, structural components for wind energy.

15. A process for making a composite structure having a surface, said process comprises a step of:
impregnating with the matrix resin composition recited in claim 1 the fibrous material recited in claim 1 wherein at least a portion of the surface of the composite structure is made of the surface resin composition recited in claim 1.
